(19) United States
(12) Patent Application Publication
(10) Pub. No.: US 2023/0279938 A1
(43) Pub. Date: Sep. 7, 2023

(54) 3-POINT TORQUE SUPPORT

(71) Applicant: SL-TECHNIK GMBH, St. Pantaleon (AT)

(72) Inventor: Thilo SOMMERAUER, Gilgenberg am Weilhart (AT)

(73) Assignee: SL-TECHNIK GMBH, St. Pantaleon (AT)

(21) Appl. No.: 18/043,588

(22) PCT Filed: Sep. 4, 2020
(86) PCT No.: PCT/EP2020/074826

§ 371 Date: Mar. 1, 2023

(51) Int. Cl. F16H 57/025; F23K 3/00

(52) U.S. Cl. CPC F16H 57/025; F23K 3/00

(57) ABSTRACT

A torque support for a transport device for fuels of a biomass heating system, including: a base plate having three legs and three sides; and a torque support, wherein the torque support is a 3-point torque support that comprises three fastening points for connecting the base plate to a support structure.

### CROSS-REFERENCE TO RELATED APPLICATIONS

This application is a National Stage under 35 U.S.C 371 of International Patent Application No. PCT/EP2020/074826, filed Sep. 4, 2020; the disclosure of which is incorporated herein by reference in its entirety.

### TECHNICAL FIELD

The invention relates to a 3-point torque support for a rotary valve or a room discharge device/chamber discharge device of a biomass heating system.

### BACKGROUND

Biomass heating systems, especially biomass boilers, in a power range from 20 to 500 kW are known. Biomass can be considered a cheap, domestic, crisis-proof and environmentally friendly fuel. Combustible biomass or biogenic solid fuels include wood chips or pellets.

The pellets are usually made of wood chips, sawdust, biomass or other materials that have been compressed into small discs or cylinders with a diameter of approximately 3 to 15 mm and a length of 5 to 30 mm. Wood chips (also referred to as wood shavings, wood chips or wood chips) is wood shredded with cutting tools.

Biomass heating systems for fuels in the form of pellets and wood chips essentially feature a boiler with a combustion chamber (the burning room) and with a heat exchange device connected to it. Various accessories are regularly available, such as fuel delivery devices, control devices, probes, safety thermostats, pressure switches, flue gas or exhaust gas recirculation, boiler cleaning and a separate fuel tank.

Such an accessory is a rotary valve/rotary feeder/cellular wheel sluice. A rotary valve is used in biomass heating systems when feeding pellets or wood chips.

Cellular wheel sluices of the generic type for this application are known; they are usually used for the metered/portioned delivery of biogenic solid fuels (free-flowing, granular solid or small-particle bulk material) in a transport line to the combustion chamber.

Among other things, due to the particulate design of the solid fuels, the operation of the rotary valve can cause a noise load, wherein the noises or vibrations produced by the rotation of the cellular wheel can propagate, for example, over the drive axle and the housing.

Difficulties also occur in particular when moist or concentrated fuels are passed through in the lock and in particular solids adhering in the grooves of the cellular wheel. Here, considerable driving forces may be required to ensure the propulsion/movement of the fuel. This can also increase the noise generation during the drive.

During the operation of such locks, it occurs, for example, that a part of the solid material to be introduced settles between the housing and the cellular wheel and prevents or impedes a rotation of the cellular wheel and jerky movements of the cellular wheel occur.

When such a rotary valve blocks during operation, high moments of inertia occur due to the generally high rotated masses. In the case of jerky blocking of the cellular wheel, for example when bulk material jams between the cellular wheel and the housing, damage to the cellular wheel drive, in particular to a transmission from the latter, can therefore occur if there is insufficient support. Such blocking can certainly occur several times per hour during operation, which means that the development of noise is not negligible.

EP 0 885 113 B1, DE 38 42 811 A1 and DE 1 056 052 B disclose cellular wheel sluices or cell rolls having a housing with an inlet and an outlet and a rotary drive. The rotary drive of EP 0 885 113 B1 has an overload clutch. The rotary drive of DE 38 42 811 A1 has a slip clutch. The rotary drive of DE 1 056 052 B has an elastic coupling. The drive for the cell roller of DE 1 056 052 B can have a clutch between a drive shaft of a DC motor and the cell roller.

EP 2 587 150 A2 discloses a room discharge device as a further accessory of a biomass heating system. In this case, the space-discharge device is described as a device for discharging bulk material, in particular biomass bulk material, from a storage space with a rotatably driven rotor carrying discharge arms at the bottom of the storage space, the discharge arms of which rotor supply the bulk material to a conveyor, the rotor being covered on the head side by a rotary disk rotatably mounted on the rotor. Devices of this type are used for discharging bulk material from storage rooms, in particular from bunkers or silos, for the purpose of supplying it to a furnace of a biomass heating system. The conveyor to which the rotationally driven discharge arms feed the bulk material is usually a conveyor screw arranged in an upwardly open housing, which feeds the bulk material in a metered manner during firing. The discharge arms rotating with the rotor have the task of feeding the bulk material distributed over the storage space base surface to the upwardly open conveyor screw. The rotationally driven rotor carrying the discharge arms is typically driven by an angular gear on the conveyor worm. In order to keep the rotor torque and the required drive power low, the discharge arms are either flexible, in the manner of leaf springs, or are designed to be bendable. With a sufficiently filled storage space, the discharge arms can retract towards the rotor or can wind around the rotor when the rotor is rotating, wherein they may at least partially disappear under the turntable.

EP 2 966 349 A1 likewise discloses a generic space discharge device. Such a discharge device is also known, for example, from DE 34 10 546 A. There, a screw conveyor serves as a conveyor between the bulk material storage and the burning device or combustion device. This screw conveyor is helical. The bulk material is bulged and compressed in the cavities of the coil. The forces and stresses exerted by the bulk material in the screw conveyor increase proportionally with increasing distance from the bulk material storage device. In the long term, this implies a considerable load on the drive train and in particular on the bearings of the screw conveyor. As a result of the compression of the bulk material, the fuel or the bulk material can also be compressed in an undesirable manner. Also, the fuel may alter a microstructure in an undesirable manner. DE 32 00 727 also discloses a further space-discharging device with a screw conveyor between the bulk material store and the combustion device.

Thereby, the operation of a room discharge device as well as the operation of a rotary valve/cellular wheel sluice can cause a considerable and undesired noise pollution. This is due to the type of drive, as well as the fuel, which is transported in a channel with a screw conveyor, i.e., to the application. However, especially in the case of biomass heating systems for residential buildings, there is a requirement to keep their noise emissions low.

In this case, the drive, for example an electric motor, also represents a noise or sound source, in particular when the drive stops.

In the case of conveyor screws and also screw presses and the like, it is also already known to connect the screw to its drive device in such a way that the entire screw or a part thereof undergoes a reciprocating (shaking or vibrating) movement in the axial direction or an alternating rotational speed or both from the drive device during the rotation. In this case, it is only a matter of reducing the friction between the screw and the mass advanced by it, whereby the rotational movement of the mass is to be kept as small as possible. This type of controlled drive also disadvantageously causes an increased noise load.

In order to ensure simple design conditions when driving the rotor of a rotary valve for charging a furnace, in particular of boilers, it is furthermore known from AT 13 782 U1 to mount the transmission of the gear motor on the rotor shaft of the cellular wheel sluice via a plug-in coupling and to support it relative to the sluice housing via a torque support. This torque support can consist of a frame, which can be screwed onto the gear housing and is parallel to the rotor shaft and which engages with one leg around the lock housing on a circumferential side and is secured in this stop position by a latching projection of the lock housing, which latching projection is radial with respect to the rotor shaft. The frame of the torque support provided with a corresponding latching recess must therefore first be slipped onto the latching projection radially with respect to the lock housing before the frame can be screwed tightly to the transmission housing.

With the fastening of the torque support to the transmission housing, the transmission motor is not only supported against rotation about the rotor shaft, but is also secured against axial withdrawal from the rotor shaft, because the latching projection of the lock housing, which latching projection positively engages in the latching projection of the frame leg, forms an axial stop for the torque support and thus for the transmission motor. Since the torque support is arranged on the side of the gear housing opposite the motor part of the gear motor with respect to the rotor shaft, the motor part can be provided independently of the torque support on the side of the gear housing facing the lock housing, in order to facilitate access, in particular to the feed screws connected to the cellular wheel lock on the inlet and outlet sides, from the side opposite the motor part of the gear motor, despite a space-saving design. Depending on the installation conditions, however, this means that the motor part is to be arranged selectively on one of the two sides of the lock housing, which requires different torque supports. Furthermore, due to the mounting of the gear motor, the rotor shaft is also subjected to bending stress.

In this case, the torque support of AT 13 782 U1 is provided by means of two rotary stops for load transfer on the lock housing and is in this respect designed as a 2-point support. Such a process may have stability problems under certain circumstances and requires a large amount of material during production. In addition, it has been found that in this arrangement, additional noises are produced when the motor is twisted on the torque support.

Furthermore, conventional torque supports may have the problem that they are complex to manufacture and require a lot of material to have the required strength.

In addition, there may be the problem that conventional torque supports must be very stable and firmly constructed, which, however, favors the transmission of sound waves or noises.

The foregoing is also applicable to the mechanics of a torque support of a space discharge device or an auger.

In view of the above-mentioned problems, it is an object of the present invention to provide a torque support for a transport device for fuels of a biomass heating system, which provides a stable fastening.

A further object can be to reduce the noise emission.

A further object may be that the torque support can be produced in a simple and cost-effective manner.

Further objects can be to provide a torque support for a transport device for fuels of a biomass heating system, which saves material and/or is easy to produce and/or can be used as a standard component in different devices.

This above-mentioned object(s) is/are achieved by the subject matter of the independent claims. Further aspects and advantageous further embodiments are the subject of the dependent claims.

According to one aspect of the present disclosure, a torque support for a transport device for fuels of a biomass heating system is comprising: a base plate having three legs and three sides; the base plate having an axle opening for passing a driven axle; the base plate having a plurality of mounting/fastening holes for mounting/fastening a drive; each of the legs having a mounting hole/receiving hole for receiving a mounting element for mounting on the output side to a support structure.

According to a further development of the above aspect, a torque support is provided, the base plate being approximately triangular in shape; the corners of the triangular base plate being formed by the ends of the legs.

According to a further development of the above aspect, a torque support is provided, the centers of the receiving holes (forming the corners of an equilateral or isosceles triangle).

According to a further development of the above aspect, a torque support is provided, wherein an insulating bushing for sound damping is provided in a receiving hole.

According to a further development of the above aspect, a torque support is provided, wherein in each receiving hole, a respective insulation bushing is provided for sound damping.

According to a further development of the above aspect, a torque support is provided, the base plate having approximately the shape of an isosceles or equilateral triangle in the plan view.

According to a further development of the above aspect, a torque support is provided, wherein the base plate, with the exception of the plurality of fastening holes, has three axes of symmetry, which represent the bisectors of the sides, wherein the three axes of symmetry intersect the center (M) of the torque support.

According to a further development of the above aspect, a torque support is provided, the center of the axle opening being provided in the center of the torque support.

According to a further development of the above aspect, a torque support is provided, the plurality of fastening holes being at the same distance from the center of the torque support.

According to a further development of the above aspect, a torque support is provided, wherein the sides are provided in a waisted manner.

According to a further development of the above aspect, a torque support is provided, each of the legs having a bend, the plane of the base plate with the receiving holes being different from the plane of the base plate with the fastening holes for fastening a drive.

According to a further development of the above aspect, a torque support is provided, the insulating bushings being made of plastic or rubber.

According to a further development of the above aspect, a rotary valve with a torque support described herein is provided.

According to a further development of the above aspect, a room discharge device with a torque support described herein is provided.

### BRIEF DESCRIPTION OF THE DRAWINGS

The torque support according to the invention is explained in more detail below in exemplary embodiments and individual aspects with reference to the figures of the drawing:

FIG. 1 shows a three-dimensional oblique view of a torque support;

FIG. 2 is a top view of the torque support of FIG. 1;

FIG. 3 is a cross-sectional view of the torque support of FIG. 1 and FIG. 2;

FIG. 4 shows an exploded drawing of a rotary valve with a torque support of FIGS. 1 to 3; and

FIG. 5 is an exploded view of a room discharge device with a torque support of FIGS. 1 to 3.

### DETAILED DESCRIPTION

Hereinafter, an embodiment of the present disclosure and two applications thereof will be disclosed merely by way of example with reference to the accompanying drawings. However, the embodiment and the terms used herein are not intended to limit the present disclosure to this particular embodiment, and it should be understood that the embodiment includes various changes, equivalents, and/or alternatives according to the embodiments of the present disclosure.

If more general terms are used in the description for the features or elements illustrated in the figures, it is intended that not only the special feature or element is disclosed in the figures for the person skilled in the art, but also the more general technical teaching.

With reference to the description of the figures the same reference signs may be used in each figure to refer to similar or technically corresponding elements. Furthermore, for the sake of clarity, more elements or features can be represented by reference numerals in individual detail or detail views than in the overview views. It can be assumed here that these elements or features are also correspondingly disclosed in the other figures, even if they are not explicitly listed there.

It should be understood that a singular form of a noun corresponding to an object may include one or more of the things, unless the context in question clearly indicates otherwise.

For example, a term “configured to” (or “set up”) used in the present disclosure may be replaced with “suitable for,” “adapted to,” “made to,” “capable of,” or “designed to,” as technically possible. Alternatively, in a particular situation, an expression “device configured to” or “set up to” may mean that the device can operate in conjunction with another device or component, or perform a corresponding function.

### 3-Point Torque Support

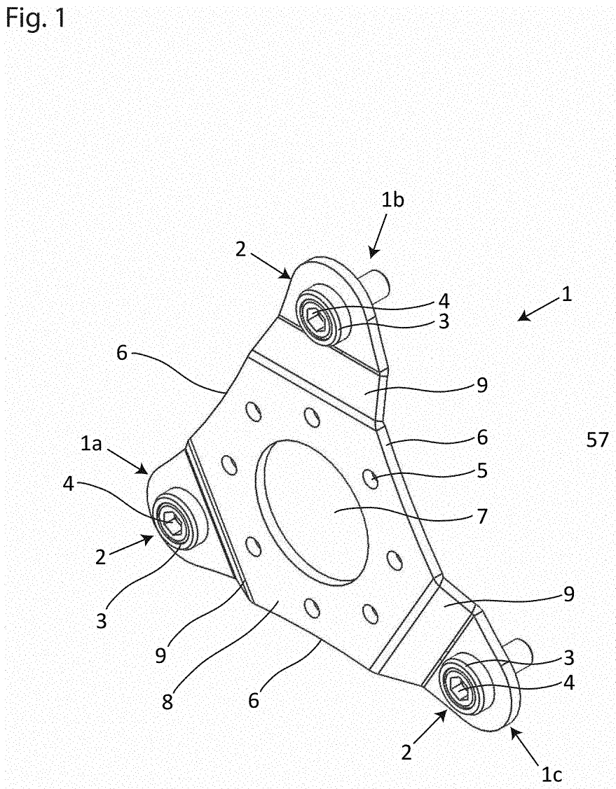

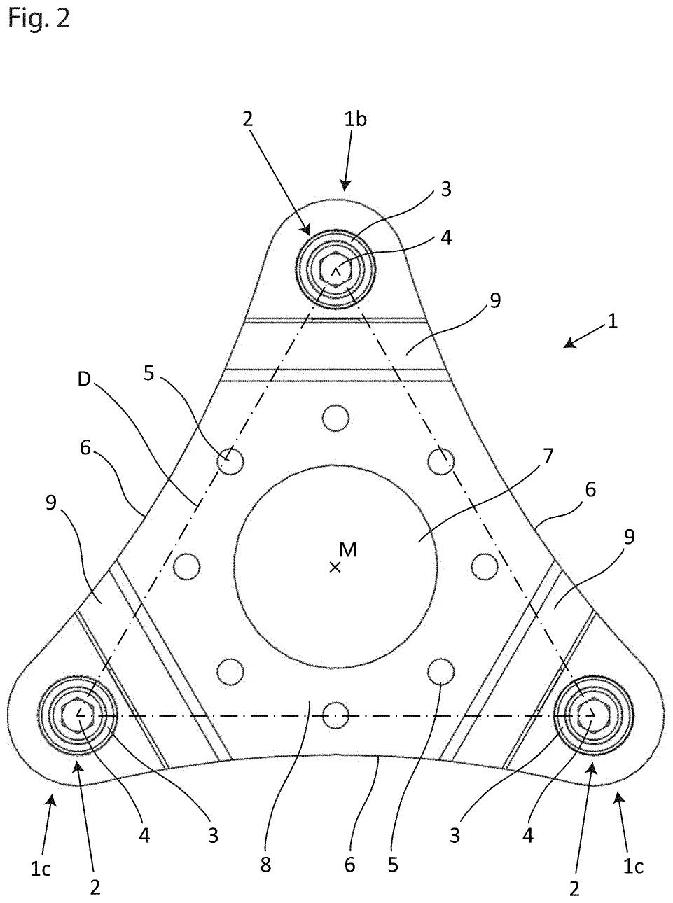

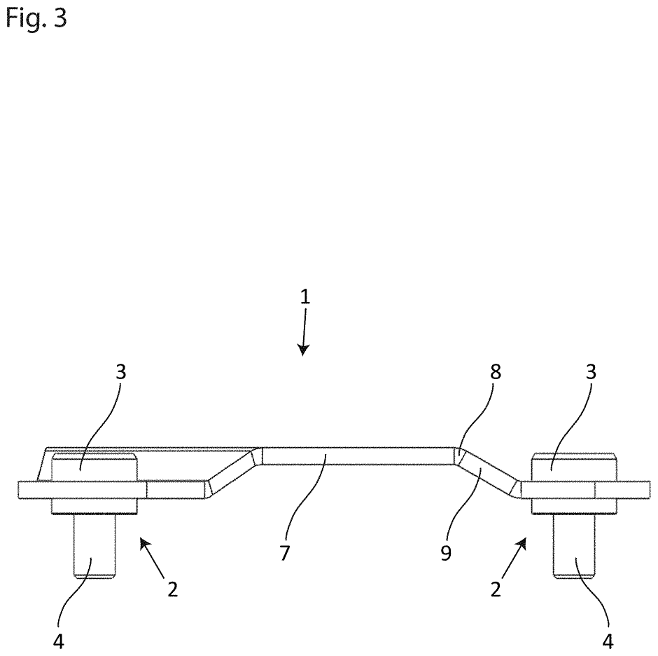

FIG. 1 shows a three-dimensional oblique view of an example of a torque support 1 according to the invention. FIG. 2 is a top view of the torque support 1 of FIG. 1. FIG. 3 is a cross-sectional view of the torque support 1 of FIG. 1 and FIG. 2. The same reference numerals designate correspondingly identical parts/features in FIGS. 1 to 3.

Referring to FIGS. 1 to 3, the torque support 1 has a base plate 8 with an axle opening 7. The base plate 8 in turn has three legs 1a, 1b, 1c, which are arranged around the axle opening 7. The ends of the three legs 1a, 1b, 1c each point outward from the center M of the torque support 1. These ends are thus also the distal ends of the base plate 8. These ends may be provided rounded. However, this property does not change the fact that the base plate 8 can be designated as triangular in plan view, even if it has no hard corners or a waist (see later). Furthermore, the base plate has the three sides 6 of the base plate 8.

The base plate 8 may be made of a metal, preferably a torsionally rigid hard metal. Thereby, the base plate 8 can be cut and metal formed for the production, for example, by the laser cutting method. Alternatively, however, the base plate 8 may also be made of a plastic.

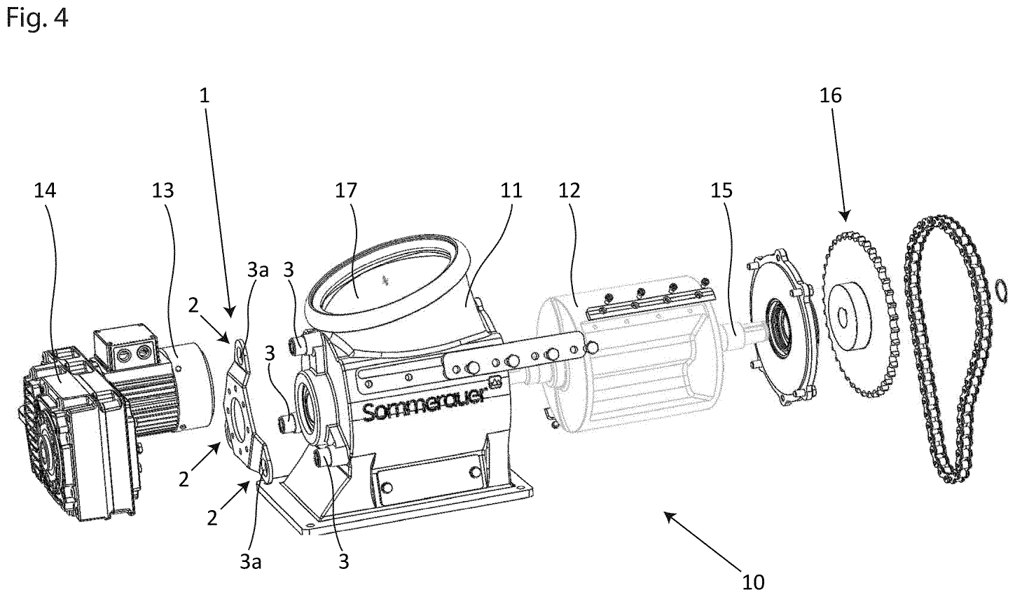

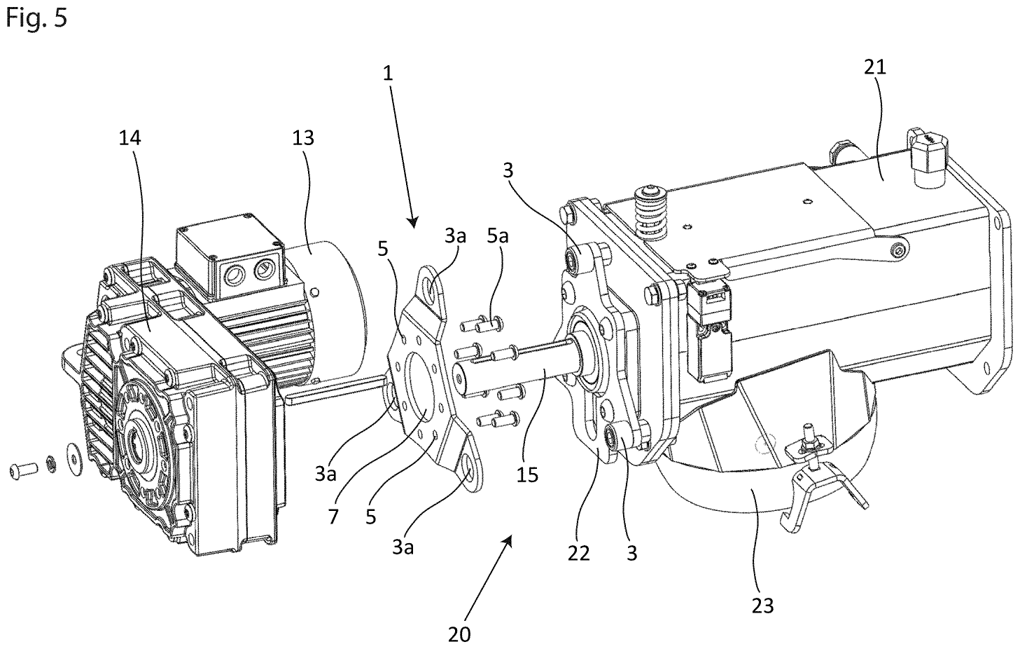

The axle opening 7 serves for the passage of a drive axle 15 (cf. FIG. 4 and FIG. 5) or drive shaft of an accessory of a biomass heating system, for example the drive shaft of a screw conveyor for biogenic fuel or the drive shaft of a rotary valve through the torque support 1. Optionally, the axle opening 7 may be provided for a rotatable mounting of the drive axle.

The base plate 8 has holes 5 or bores 5 for rigid connection to a drive 13 (shown in FIG. 4 and FIG. 5). The holes 5 can be arranged on a circular line around the axle opening 7 at regular intervals. Alternatively, however, the holes 5 can also be arranged differently depending on the requirements of the drive to be fastened (and, for example, according to the position of its fastening holes or screw holes).

In the plan view of FIG. 2, the base plate 8 can now be referred to as a roughly triangular or triangular plate 8. In this case, the base plate 8 (with the exception of the holes 5) has three axes of symmetry, which are both the central perpendicular and the lateral bisectors. These three axes of symmetry with respect to the outer contour of the base plate 8 extend through the center M and in each case through the center of the respective leg 1a, 1b, 1c.

The three legs 1a, 1b, 1c extend in the distal direction and taper with the distance to the center M of the torque support 1.

Furthermore, the base plate 8 has the three sides 6, which are formed (optionally) as lateral waists 6 in order to save material. The three waists 6 are thus provided on the outer sides 6 of the base plate 8 of the torque support 1.

The axle opening 7 may be provided at the center M of the torque support. In this case, the axle opening 7 is a (preferably circular) hole, the center M of which can be the center or the geometric center of gravity of the torque support 1.

Furthermore, the torque support 1 has three fastening points 2 for connection to a support structure of a device, for example to a housing of a transport device for fuels of a biomass heating system. These three fastening/attachment points 2 are respectively provided at the distal ends of the legs 1a, 1b, 1c. A 3-point torque support 1 is thus provided.

The three fastening points 2 of the three legs 1a, 1b, 1c (and thus the legs 1a, 1b, 1c) each have in detail a receiving hole 3a (shown in FIGS. 4 and 5) for an insulating bushing 3.

The insulating bushing 3 can consist of a plastic (for example POM, PPs, PVC, PP, PE, PPs-el, PE-el, PVDF or rubber), which can preferably have sound-absorbing properties. The three insulating bushings 3 are each bush-shaped and have in their center an opening for (preferably form-fitting) receiving a fastening element 4, for example a screw 4 (cf. FIG. 4 and FIG. 5).

The respective center of the three receiving holes 3a form the three corners of a triangle D (see the dash-dot line of FIG. 2), which is preferably formed on the same side. The center of gravity of this triangle D may in turn be the center M of the torque support 1.

Furthermore, the three legs 1a, 1b, 1c are each designed to be bent by means of a (preferably double) bent or angularly arranged plate section 9. Thus, a crank 9 is provided which enables the insulating bushings 3 to rest centrally on the legs 1a, 1b, 1c of the base plate 8 (see in particular the left side of FIG. 3 for the shape of the crank 9). In other words, the base plate 8 with its legs 1a, 1b, 1c has a bridge-shaped cross section (cf. FIG. 3), with the legs 1a, 1b, 1c resting on the output side or on the side of the output. This also ensures that the insulating bushes 3 alone rest on the output side, inter alia in order to reduce the sound transmission through the torque support 1.

The receiving holes 3 of the base plate 8 do not lie in the same (cross-sectional) plane as the axle opening 7, which further improves the sound damping and also the assembly.

It can also be seen from FIG. 3 that the torque support 1 with its receiving holes 3 can be set up such that the receiving holes 3 can be pushed over the insulating bushes 3.

For example, the insulating bushings 3 can already be mounted in advance on the output-side housing 11, wherein then receiving holes 3 are pushed onto the insulating bushings 3, and wherein then the fixing can take place by means of the further fastening elements, for example bolts or screws (cf. also FIG. 5, wherein the insulating bushings 3 are preassembled on the output side, and then the torque support 1 with its receiving holes 3 is pushed onto the insulating bushings 3).

The three insulating bushes 3 can alternatively or additionally have a stop, so that they can be inserted into the receiving hole 3a until the stop of the insulating bush 3 rests on the base plate. Then, as a result, the torque support 1 with the insulating bushes can be screwed to the output-side housing.

### Rotary Valve with Torque Support

FIG. 4 shows an exploded view of a rotary valve with a torque support 1 of FIGS. 1 to 3.

The torque support 1 is provided between the drive 13 and a housing 11 of a rotary valve 10.

On the drive side, the drive 13, for example an electric motor, is provided with a transmission 14/gear 14 with a receptacle for a drive axle 15 or drive shaft 15 of the rotary valve 10.

On the output side, the housing 11, a cellular wheel 12 with two chambers, a mechanism 16 for a worm drive (not shown) and a fuel supply port 17 are provided.

The torque support 1 serves for the stable fixing/mounting of the drive 13 and the transmission 14, which together provide a transmission motor.

In the assembled state, the axle 15 is provided guided through the torque support 1.

The transmission 14 is connected or screwed to the torque support 1 by means of fastening elements 5a, for example screws 5a.

A counterpart to the torque support 1 is provided on the housing 11, to which counterpart the insulating bushings 3 are attached. The torque support 1 can be pushed with its receiving holes 3a onto the insulating bushes 3, and then the torque support 1 can be screwed to the housing 11.

As a result or in the assembled state, the torque support 1 is attached to the housing 11 by means of three fastening points 2, the three fastening points 2 having the same distance from the center M of the axle opening 7 and being arranged in a triangularly symmetrical manner.

In addition, the insulating bushings 3 are located in the (solid) sound transmission path between the housing 11 and the motor 13.

### Room Discharge Device with Torque Support

FIG. 5 is an exploded view of a room discharge device 20 with a torque support 1 of FIGS. 1 to 3. Thus, it is clarified that the present torque support can be used for various types of transport devices for biomass heating devices. The same reference numerals as in FIG. 4 denote the same or similar parts/features.

The space discharge device 20 has a conveying channel 21 for a fuel, in which (not shown) a conveying screw is provided for conveying the fuel, the conveying screw being driven via the axle 15. The fuel is conveyed in FIG. 5, for example, from the right side through the delivery channel 21 to the left and then down through the outlet 23. The conveying channel 21 is part of a support structure of the space discharge device 20.

In FIG. 5, too, the torque support 1 connects the drive side to the output side. On the output side, a counterpart, in the present case a suspension 22 with a bearing for the axle 15, to the torque support 1 is provided, to which the insulating bushes 3 are attached. Incidentally, counter nuts for the screw connection are shown to the right of the insulating bushes.

Here too, the torque support 1 can be pushed onto the insulating bushes 3. The insulating bushings 3 are thus advantageously located in the (solid-state) sound transmission path between the fuel delivery channel 21 and the motor 13.

As a result, or in the assembled state, the torque support 1 is attached to the conveying channel 11 by means of three fastening points 2, the three fastening points 2 having the same distance from the center M of the axle opening 7, and being arranged triangularly symmetrically.

### Advantages

The purpose of the torque support 1 is first of all to absorb the differential torque of the drive and output and to introduce it into the support structure (for example, housing or frame). In this case, not only the torque in the axis of the drive axle/drive shaft is to be absorbed in the present case, but also laterally acting torques (or also bending torques) which can result in particular during the transport of piece goods by means of a screw or sluice. In this case, for example, pellets can wedge laterally in the conveying channel 21, as a result of which transverse and bending forces can be produced on the torque support via the axle 15, which forces can also be reinforced again by the lever action of the axle 15 (depending on the further axle bearings). Thus, distortions can occur in different directions.

However, the suspension of the torque support 1 at three points 2 mechanically ensures that a high stability of the torque support 1 also exists with respect to such twists. The three fastening points 2 ensure that forces in all relevant directions can be absorbed by the torque support 1.

In the case of the conventional torque support of AT 13 782 U1 with only two fastening points, lateral forces which lie transversely to the connecting line of the fastening points can be absorbed only inadequately, for example as a result of tests. Thus, the present torque support 1 is a support fixed or resting on three fastening points 2, wherein conventional torque supports for accessories or transport devices in biomass heating systems, in contrast thereto, are 2 or 1-point supports (i.e. with two or one fastening point).

If, however, four or more fastening points were now provided for further increasing the stability, the attenuation of the noises or of the sound by the torque support deteriorates, since more fastening points mean more contact surface, more material for the sound conduction and thus a lower sound resistance between the drive side and the output side.

In this respect, it has been found in the present case that three fastening points are the ideal compromise between mechanical stability (also in transverse directions to the axle 15 or under bending stress) and the sound-damping properties of the torque support 1.

In addition, the position of the fastening points 2 or of the centers of the receiving holes 3 at the corners of an equilateral triangle contributes to increasing the mechanical stability, as is apparent to the person skilled in the art from mechanical/physical considerations when considering the triangular geometry disclosed herein. The position of the fastening points 2 also contributes to a simple mounting on the counterpart, since the points 2 must necessarily lie in one plane, and, for example, manufacturing tolerances can be compensated or handled more easily than, for example, in the case of a torque support with four more fastening points.

Furthermore, the base plate is also more stable in the approximately triangular shape or the symmetrical shape as an equilateral triangle and easy to handle in assembly.

Furthermore, (preferably) the noise generation or noise emission of a transport device of a biomass heating system is to be further reduced. The three insulating bushings 3, which represent a barrier in the sound conduction path between the drive 13 and the output side, serve for this purpose.

Here, a synergy between the three fastening points 2 and the three insulating bushes 3 occurs: If more than three insulating bushings 3 were provided, their common sound resistance would decrease, which would impair the damping effect of the torque support 1.

Furthermore, a spacing of the holes 5 for the drive to the receiving holes 3a in the thickness direction is also provided by means of the offset 9. This also improves the damping effect of the torque support 1 due to the angular configuration of the resulting sound conduction paths in the base plate 8 and, for example, the resulting interference between the sound conduction threads.

The crank 9 also serves for simple assembly of the torque support.

In the present case, it has thus been recognized that the torque support 1 plays an important role in the transmission of the sound or noises in the device.

In this respect, the above-described design of the torque support 1 with the insulating bushings 3 serves to reduce or even interrupt the transmission of sound or noise, in particular from the drive 13 to the housing 11, while at the same time providing an approximately optimal mechanical stability, in particular for the above applications (cf. FIG. 4 and FIG. 5).

In addition, it has been recognized in the present case that the disturbing noise emissions can also arise from the torque support itself and the fastening of a conventional torque support itself.

In this case, a noise can be generated by twisting a base plate (provided, for example, as a double angle) of the prior art under stress, a metal-on-metal noise being generated between the fastening elements (metal bolts or screws) and the base plate of a torque support, since these work on one another under stress.

The use of the insulating bushing 3 according to the invention prevents this rubbing of metal on metal, whereby a disturbing metal-on-metal noise can be avoided.

In addition, the present torque support is quite simple to produce and requires comparatively little material. With this, it is cost-saving.

The insulating bushings 3 can be produced in large numbers, for example, by injection molding or by deep-drawing.

In summary, a 3-point torque support (three-point bearing) with optional integrated noise-absorbing fastenings/attachments (the insulation bushings 3) is disclosed. Due to its geometry, the present torque support is particularly stable with a simple construction. Noise generation by the torque support itself or its contact points with other metal parts is advantageously avoided.

### Other Embodiments

The invention admits other design principles in addition to the embodiments and aspects explained. Thus, individual features of the various embodiments and aspects can also be combined with each other as desired, as long as this is apparent to the person skilled in the art as being executable.

Although the torque support 1 with its legs is shown approximately symmetrically (except for the fastening holes 5, which are arranged in each case depending on the drive to be fastened), the torque support 7 can also be provided asymmetrically as long as it has three fastening points 2.

Although the torque support 1 with its base plate 8 is described in plan view in the form of an equilateral triangle (and the corresponding symmetry thereof), the torque support 1 can also be provided with other symmetries (for example an equilateral and not equilateral triangle, or a right-angled triangle).

Although the three legs 1a, 1b, 1c are provided identically in the embodiment, they may differ from one another in shape and structure.

The axle opening/axle orifice 7 may also be provided offset from the center of the torque support 1. In this case, in particular, the center M of the hole of the axle opening 7 can be provided offset or displaced with respect to the geometric center of the torque support 1.

Although the symmetry of the fastening points 2 is formed as an equilateral triangle, another triangle can also be selected as the basic shape, for example an equilateral (and not equilateral) triangle or a right-angled triangle (depending on the mechanical requirements of the specific application, which dictate the forces acting on the torque support 7).

Although the axle opening 7 serves for the rotatable mounting of a drive axle for an accessory of a biomass heating system, the axle opening 7 can also accommodate other axes relating to other applications. With this, the torque support 1 can also be used differently as long as a torque of an axle is to be supported.

A plain bearing, for example made of plastic, may optionally be provided in the axle opening 7.

The support structure can be any structure that allows a drive to be fastened via a torque support.

Depending on the application, the insulating bushes 3 may also be omitted. In this way, the torque support 1 can also be fastened without an insulating bushing 3.

Fuels other than wood chips or pellets can be used as fuels for the biomass heating system.

The embodiment(s) disclosed herein are provided for description and understanding of the disclosed technical facts and are not intended to limit the scope of the present disclosure. Therefore, this should be construed to mean that the scope of the present disclosure includes any modification or other various embodiments based on the technical spirit of the present disclosure.

### LIST OF REFERENCE NUMERALS

1 torque support
1a, 1b, 1c legs
2 mounting points of the torque support
3 Insulation bushing
3a receiving hole for the plastic bushing
4 fastening element/metal bolt/screw
5 mounting holes for the drive
5a mounting elements/mounting bolts/mounting screws for the drive
6 pages/waists
7 axle opening
8 base plate
9 crank
10 Rotary valve
11 housing of the rotary valve
12 cellular wheel
13 drive
14 transmission
15 shaft/axle/axis
16 mechanism for worm drive (not shown)
17 fuel supply port/opening
20 room discharge device
21 fuel delivery channel
22 torque support suspension
23 outlet for the fuel

1. A rotary valve for a transport device for fuels of a biomass heating system, comprising:
a base plate having three legs and three sides; and
a torque support, wherein the torque support is a 3-point torque support that comprises three fastening points for connecting the base plate to a support structure,
wherein the base plate has an axle opening configured to pass a driven axle through,
wherein the base plate comprises a plurality of fastening holes configured for fastening a drive, and
wherein each of the legs comprises a receiving hole configured to receive a fastening element for fastening on an output side to a support structure of the transport device.

2. The rotary valve according to claim 1,
wherein the base plate is approximately triangular in shape; and
wherein ends of the triangular in shape base plate are formed by the ends of the legs.

3. The rotary valve according to claim 1,
wherein centers of the receiving holes form corners of an equilateral or isosceles triangle.

4. The rotary valve according to claim 1,
wherein an insulating bush for sound damping is provided in a receiving hole.

5. The rotary valve according to claim 1,
wherein in each receiving hole a respective insulation bushing is provided for sound damping.

6. The rotary valve according to claim 1,
wherein the base plate in a top view is approximately an isosceles or isosceles triangle.

7. The rotary valve according to claim 1,
the base plate has three axes of symmetry representing bisectors of the sides, and three axes of symmetry intersecting a center of the torque support.

8. The rotary valve according to claim 1,
wherein the center of the axle opening is provided in the center of the torque support and/or the center of the base plate.

9. The rotary valve according to claim 1,
wherein the plurality of mounting holes are provided at the same distance from the center of the torque support.

10. The rotary valve according to claim 1,
wherein the sides are provided in a waisted manner configuration.

11. The rotary valve according to claim 1,
wherein each of the legs has an offset, wherein a first plane of the base plate with the receiving holes differs from a second plane of the base plate with the fastening holes for fastening a drive.

12. The rotary valve according to claim 4,
wherein the insulation bushes are made of plastic or rubber.

13. (canceled)

14. (canceled)
